(19) United States
(12) Patent Application Publication
(10) Pub. No.: US 2016/0059551 A1
(43) Pub. Date: Mar. 3, 2016

(54) LIQUID EJECTING HEAD AND LIQUID EJECTING APPARATUS

(71) Applicant: CANON KABUSHIKI KAISHA, Tokyo (JP)

(72) Inventors: Kyota MIYAZAKI, Tama-shi (JP); Akira Yamamoto, Yokohama-shi (JP); Yasuhiko Osaki, Yokohama-shi (JP); Toshiaki Hirosawa, Hiratsuka-shi (JP)

(21) Appl. No.: 14/833,708

(22) Filed: Aug. 24, 2015

(30) Foreign Application Priority Data
Sep. 1, 2014 (JP) 2014-177286

(51) Int. Cl. B41J 2/14

(52) U.S. Cl. CPC B41J 2/14016

(57) ABSTRACT

There is provided a miniaturized liquid ejecting head and a liquid ejecting apparatus on which the liquid ejecting head is mounted. A plurality of ink supply ports are formed on a print element substrate to supply ink to a bubble generation chamber. Electrothermal transducing elements are arranged only in regions interposed between the plurality of ink supply ports each other. A drive circuit for driving the electrothermal transducing element is arranged in a region that is not included in the region interposed between the plurality of ink supply ports each other.

### BACKGROUND OF THE INVENTION

1. Field of the Invention

The present invention relates to a liquid ejecting head that drives heater elements to eject liquids from ejection ports, and a liquid ejecting apparatus that mounts the liquid ejecting head thereon.

2. Description of the Related Art

There is a liquid ejecting apparatus with a system that uses heater elements as print elements. In a liquid ejecting head of the liquid ejecting apparatus using this system, a heater element is arranged for each of ejection ports on an element substrate. A print signal is applied to the heater element to give thermal energy to ink, and ink droplets are ejected from the ejection port by the pressure of air bubbles generated then.

There is a liquid ejecting head in the form where a plurality of liquid supply ports are formed on a print element substrate. Japanese Patent Laid-Open No. 2006-192891 discloses the liquid ejecting head that is provided with the print element substrate in which the plurality of liquid supply ports are thus formed. Japanese Patent Laid-Open No. 2006-192891 discloses the liquid ejecting head in which five lines of liquid supply ports are formed on the print element substrate.

In a case where the plurality of liquid supply ports are formed on the print element substrate as similar to the liquid ejecting head disclosed in Japanese Patent Laid-Open No. 2006-192891, there occurs regularly a difference in temperature between a position between the liquid supply ports on the print element substrate and a position outside of each of the outside liquid supply ports thereon. In the position of the element substrate outside of the outside liquid supply port, the print element substrate is attached on a portion of a support member having a relatively large volume. Therefore most of heats generated in the position outside of the outside liquid supply port on the print element substrate are transferred to the support member, and a temperature of the print element substrate tends to be relatively easily lowered in the position outside of the outside liquid supply port on the print element substrate. On the other hand, in the position between the liquid supply ports each other on the print element substrate, the print element substrate is attached on a portion of the support member having a relatively small volume. The amount of heat to be transferred to the support member is small in the print element substrate between the liquid supply ports each other, and the temperature therein tends to be relatively difficult to be lowered.

Accordingly, a difference in temperature of the print element substrate occurs depending upon the position of the element substrate. As a result, a difference in temperature between liquids ejected from ejection ports occurs depending upon the position of the ejection port. Therefore a difference in properties of the liquid occurs for each ejected region, and particularly in some cases a difference in ejection amounts between the liquids ejected from the ejection ports occurs. Since the ejection amount of the liquid ejected from the ejection port differs for each region, a density difference occurs on an image formed by the ejected liquid, possibly degrading the image in quality.

### SUMMARY OF THE INVENTION

Therefore the present invention is made in view of the aforementioned subjects, and an object of the present invention is to provide a liquid ejecting head that can suppress a temperature difference between liquids to be ejected due to a position of an ejection port to be small, and a liquid ejecting apparatus on which the liquid ejecting head is mounted.

According to the present invention, a liquid ejecting head comprising: an element substrate; a support member that supports the element substrate; and an ejection port plate that is mounted to the element substrate, wherein a bubble generation chamber is defined between the element substrate and the ejection port plate to reserve liquids therein, the element substrate is provided with a heater element that heats liquid reserved in the bubble generation chamber to generate bubbles, and a plurality of liquid supply ports formed to penetrate therethrough from a front surface on which the heater element is provided to a back surface as the reverse side to supply the liquid to the bubble generation chamber, the ejection port plate is provided with ejection ports formed therein to eject the liquid from the bubble generation chamber by driving the heater element, the back surface of a portion outside of the liquid supply port and a portion between the liquid supply ports each other in the element substrate is attached to the support member, the heater element is arranged only in a first region of the element substrate interposed between the plurality of liquid supply ports each other, and a drive circuit that drives the heater element is arranged at least in a second region outside of the first region.

According to the present invention, a liquid ejecting apparatus mounting a liquid ejecting head thereon, the liquid ejecting head comprising: an element substrate; a support member that supports the element substrate; and an ejection port plate that is mounted to the element substrate, wherein a bubble generation chamber is defined between the element substrate and the ejection port plate to reserve liquids therein, the element substrate is provided with a heater element that heats the liquid reserved in the bubble generation chamber to generate bubbles, and a plurality of liquid supply ports formed to penetrate therethrough from a front surface on which the heater element is provided to a back surface as the reverse side to supply the liquid to the bubble generation chamber, the ejection port plate is provided with an ejection port formed therein to eject the liquid from the bubble generation chamber by driving the heater element, the back surface of a portion outside of the liquid supply port and a portion between the liquid supply ports each other in the element substrate is attached to the support member, the heater element is arranged only in a first region of the element substrate interposed between the plurality of liquid supply ports each other, and a drive circuit that drives the heater element is arranged at least in a second region outside of the first region.

According to the present invention, since it is possible to suppress the temperature difference between liquids to be ejected due to the position of the ejection port in the liquid ejection head to be small, occurrence of a difference in ejection amounts due to the position of the ejection port can be suppressed. Therefore it is possible to suppress occurrence of variations in density of an image formed by the liquid ejected due to the position of the ejection port to improve the image in quality.

Further features of the present invention will become apparent from the following description of exemplary embodiments (with reference to the attached drawings).

### BRIEF DESCRIPTION OF THE DRAWINGS

FIG. 1 is a perspective view illustrating a print head according to a first embodiment in the present invention;

FIG. 2 is a perspective view illustrating an inkjet printing apparatus on which the print head in FIG. 1 is mounted;

FIG. 3A is a plan view illustrating a print element substrate mounted on the print head in FIG. 1;

FIG. 3B is a sectional view taken along lines IIIB-IIIB in FIG. 3A;

FIG. 4 is a plan view illustrating the print element substrate in FIGS. 3A and 3B with a sealant covering electrode parts and electrode terminals of a support member being removed therefrom;

FIG. 5A is a plan view illustrating a print element substrate mounted on a print head according to a comparative example;

FIG. 5B is a sectional view taken along lines VB-VB in FIG. 5A;

FIG. 5C is a graph illustrating a temperature distribution for each position of the print element substrate;

FIG. 6 is a plan view illustrating a print element substrate mounted on a print head according to a modification;

FIG. 7 is a sectional view illustrating transfer directions of heat generated by driving electrothermal transducing elements in the print element substrate in FIG. 3B by arrows;

FIG. 8 is a plan view illustrating a print element substrate mounted on a print head according to a different modification;

FIG. 9A is a plan view illustrating a print element substrate mounted on a print head according to a further different modification;

FIG. 9B is a sectional view taken along lines IXB-IXB in FIG. 9A;

FIG. 10A is a plan view illustrating a print element substrate mounted on a print head according to a second embodiment in the present invention;

FIG. 10B is a sectional view taken along lines XB-XB in FIG. 10A;

FIG. 11A is a plan view illustrating a print element substrate mounted on a print head according to a third embodiment in the present invention;

FIG. 11B is a sectional view taken along lines XIB-XIB in FIG. 11A;

FIG. 12A is a plan view illustrating a print element substrate mounted on a print head according to a fourth embodiment in the present invention;

FIG. 12B is a sectional view taken along lines XIIB-XIIB in FIG. 12A;

FIG. 12C is an enlarged plan view illustrating a region XIIC in FIG. 12A; and

FIG. 13 is a perspective view illustrating a print head according to a furthermore different modification.

### DESCRIPTION OF THE EMBODIMENTS

### First Embodiment

An explanation will be made of a print head as a liquid ejecting head according to a first embodiment in the present invention.

### (Structure of Print Head)

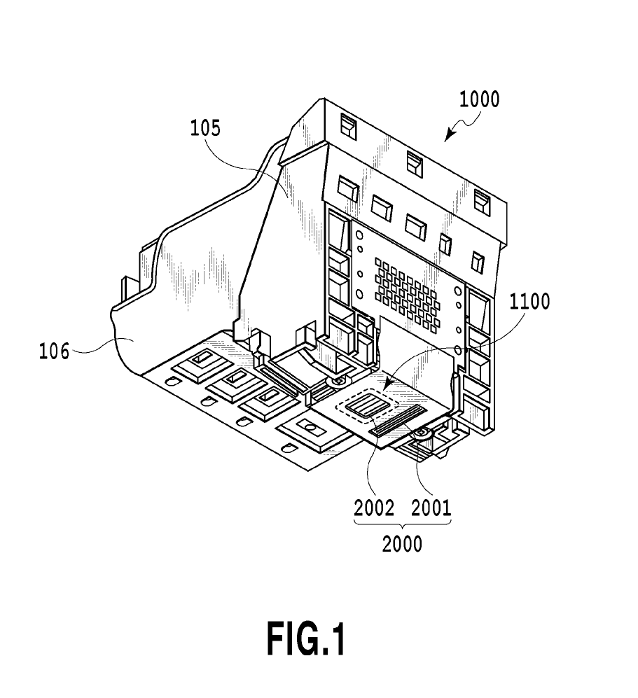

FIG. 1 is a perspective view illustrating a print head 1000 according to a first embodiment in the present invention. The print head 1000 is provided with an ink supply unit 105 on which a print element unit 1100 is mounted, and a tank holder 106 that holds ink tanks. The print element unit 1100 is provided with print element substrates 2000 mounted thereon. The print element substrates 2000 are provided with a print element substrate 2001 on which heater elements as print elements for ejecting an ink of Bk (black) are formed, and a print element substrate 2002 on which heater elements for ejecting a color ink are formed. Inks from ink tanks 26 of the respective colors set in the tank holder 106 are supplied to the respective print element substrates 2001, 2002 through the supply unit 105.

### (Structure of Inkjet Printing Apparatus)

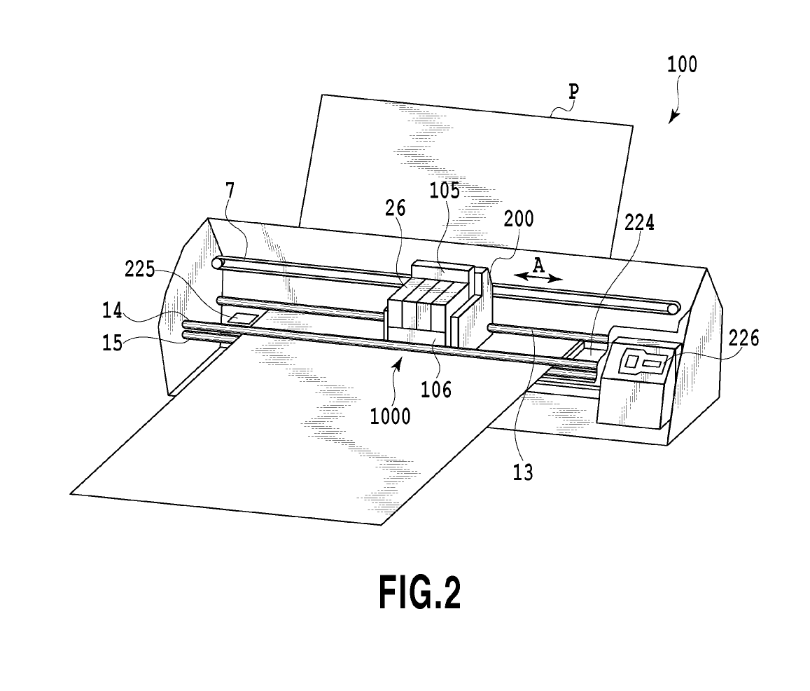

By referring to FIG. 2, an explanation will be made of an inkjet printing apparatus 100 as a liquid ejecting apparatus on which the print head 1000 is mounted. FIG. 2 is a perspective view illustrating the inkjet printing apparatus 100 according to the present embodiment. On a carriage 200 in the inkjet printing apparatus 100, the print head 1000, as well as the ink tanks 26 that reserve inks to be supplied to the print head 1000 are structured to be mounted, in a state that the ink tanks 26 are held in the tank holder 106. It should be noted that the print head 1000 and the ink tanks 26 may be formed integrally.

The inkjet printing apparatus 100 can perform a color print, and the carriage 20 is provided with the four ink tanks 26 that accommodate inks of colors composed of magenta (M), cyan (C), yellow (Y) and black (K) individually. These four ink tanks 26 each are attachable and removable independently.

There is an electrical connection between the carriage 200 and the print head 1000. The print head 1000 applies energy to the print elements formed in the print element unit in response to a print signal to selectively eject inks from the plurality of ejection ports. Thereby the ink is ejected toward a print medium for printing. Particularly the print head 1000 in the present embodiment adopts an inkjet system in which an electrical signal is applied to the heater element to heat the heater element in the ink, and thermal energy generated at that time is used to eject the ink. A guide shaft 13 is arranged in the inkjet printing apparatus 100 to extend in a main scan direction of the carriage 200. The carriage 200 is penetrated and supported by the guide shaft 13. Therefore the carriage 200 is guided and supported by the guide shaft 13 to be slidable in a direction of an arrow A along the guide shaft 13.

The carriage 200 is connected to a part of a drive belt 7 as a transfer mechanism for transferring a drive force from a carriage motor. The carriage 200 mounting the print head 1000 thereon is reciprocated by the drive force from the carriage motor. In this way, the carriage 200 reciprocates in the main scan direction crossing a conveying direction of a print medium along the guide shaft 13 by a forward rotation and backward rotation of the carriage motor. In addition, the inkjet printing apparatus 100 is provided with a scale (not shown) for indicating a position of the carriage 200 along a moving direction (arrow A direction) of the carriage 200. When the ink head 1000 ejects ink while scanning in the main scan direction, the printing is performed over an entire width of the print medium P. In addition, the inkjet printing apparatus 100 is provided with a platen opposing an ejection port face on which ejection ports of the print head 1000 are formed.

The inkjet printing apparatus 100 has a conveying roller 14 driven by a conveying motor (not shown) for conveying the print medium P. The inkjet printing apparatus 100 has a pinch roller 15 that causes the print medium P to abut on the conveying roller 14 by a spring (not shown), a pinch roller holder (not shown) that supports the pinch roller 15 that is rotatably, and a conveying roller gear (not shown) that is connected to the conveying roller 14. When the conveying motor is rotated, the drive force by the rotational drive of the conveying motor is transferred through the conveying roller gear to the conveying roller 14, whereby the conveying roller 14 is driven. In this way, the inkjet printing apparatus 100 has the conveying unit that conveys the print medium. When the conveying roller 14 is rotated in a case where the print medium P is tightly held between the conveying roller 14 and the pinch roller 15, the print medium P is conveyed along the conveying direction.

Further, the inkjet printing apparatus 100 is provided with a cap 226 that caps the ejection ports in the print head 1000 to receive ink ejected from the print head 1000. Preliminary ejections are performed in a case of capping the ejection ports in the print head 1000 by the cap 226 to suck the ink in the cap, thus making it possible to collect the ink ejected by the preliminary ejection. A platen preliminary ejection position home 224 and a platen preliminary ejection position away 225 are arranged outside of the print medium P to receive the ink ejected at the time of performing the preliminary ejection on the platen.

### (Structure of Print Element Unit)

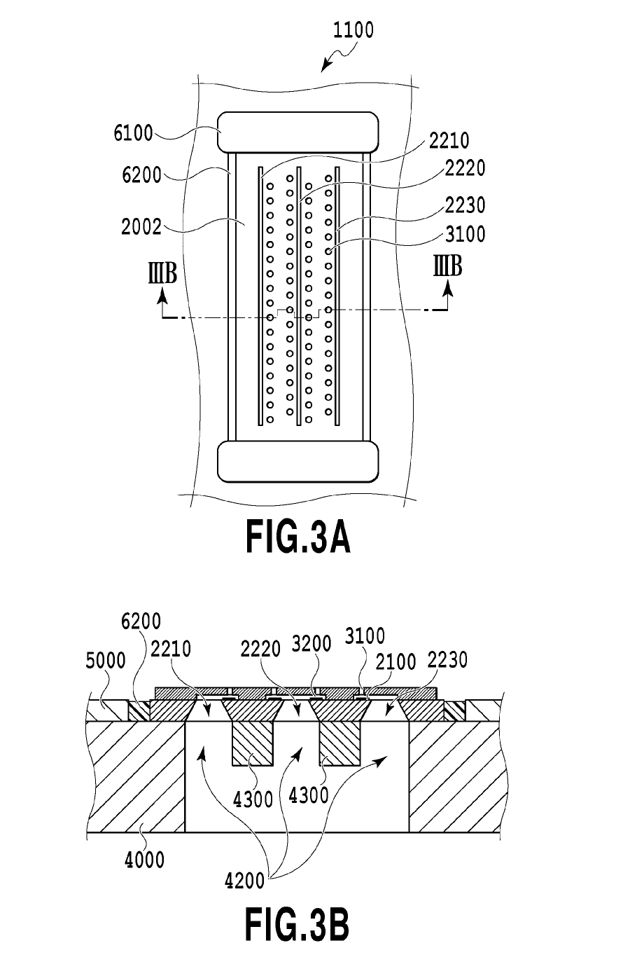

Next, an explanation will be made of the print element unit 1100 mounted on the print head 1000. FIG. 3A is a plan view illustrating the print element unit 1100 according to the present embodiment, and FIG. 3B is a sectional view taken along lines IIIB-IIIB in FIG. 3A. FIG. 3A and FIG. 3B illustrate the print element unit 1100 in a state where sealants 6100 are applied on electrical connection parts of the print element unit 1100 and sealants 6200 are applied on gaps of the periphery in the print element unit 1100.

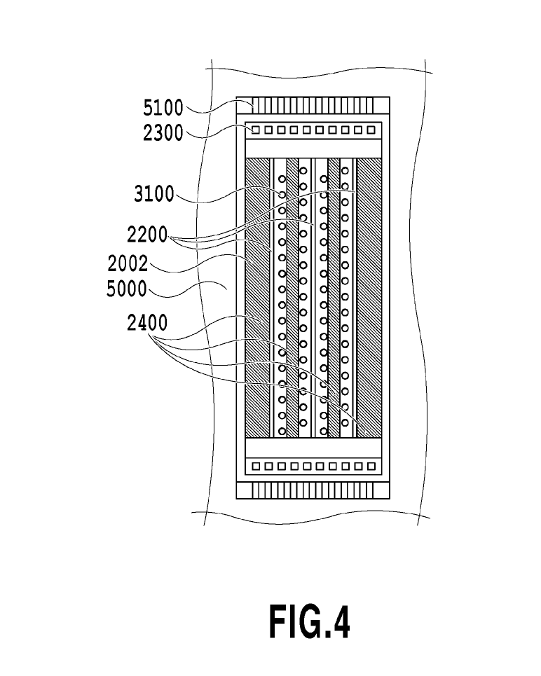

In addition, FIG. 4 is a plan view illustrating the print element unit 1100 in a state where the sealants 6100, 6200 are not applied thereon for explaining the surroundings of electrode parts 2300. In a case where the print element unit 1100 is viewed from a side where ink droplets are ejected, ink supply ports 2210, 2220, 2230 are actually not viewed because of being covered with an ejection port plate 3000. However, for the descriptive purpose, the ink supply ports 2210, 2220, 2230 are also illustrated herein. In the present embodiment, among the three ink supply ports (liquid supply ports) 2210 to 2230, the ink supply port 2220 is formed in the center, and the ink supply ports 2210, 2230 are formed in both the sides to interpose the central ink supply port 2220 therebetween. The ink supply ports 2210, 2220, 2230 are formed in the print element substrate 2002 to penetrate therethrough from a front surface on which electrothermal transducing elements 2100 are provided to a back surface of the reverse side.

The print element unit 1100 has print element substrates 2000. It should be noted that the print head 1000 may be provided with a single print element substrate 2000 or a plurality of print element substrates. In the print head 1000 in FIG. 1, two print element substrates 2000 composed of a print element substrate 2002 that ejects color inks and a print element substrate 2001 that ejects a black ink are arranged.

The three ink supply ports 2200 that are elongated groove-shaped through ports as ink flow passages are arranged in parallel on the print element substrate 2002, for example, an Si substrate having a thickness of 0.5 to 1 mm. The ink supply ports 2200 are formed by dipping the Si substrate in the etching solution such as TMAH (tetramethylammonium hydroxide) or KOH (potassium hydroxide). The electrothermal transducing elements 2100, drive circuits that drive the electrothermal transducing elements 2100, and the electrode parts 2300 are formed on the print element substrate 2002 along the respective ink supply ports 2200 by a semiconductor process. The electrode parts 2300 are arranged on the print element substrate 2002 to supply the current for driving the electrothermal transducing elements 2100, and in the present embodiment, are formed in both ends of the print element substrate 2002 in the longitudinal direction (first direction). An ejection port plate 3000 made of a resin material is arranged on the print element substrate 2002. Bubble generation chambers 3200 and ejection ports 3100 are formed in the ejection port plate 3000 by a photolithographic technology. The ejection port 3100 is formed in a position of opposing the electrothermal transducing element 2100 in the ejection port plate 3000.

The bubble generation chambers 3200 that reserve therein ink are defined between the print element substrate 2002 and the ejection port plate 3000.

In the present embodiment, a support member 4000 is formed of alumina having a thickness of 0.5 to 10 mm. It should be noted that the material forming the support member 4000 may be formed of another material as long as a material having a linear expansion coefficient equivalent to that of the material of the print element substrate 2000 is used. Examples of a material having the above linear expansion coefficient, as well as having thermal conductivity equivalent to or more than that of the material of the print element substrate 2000 include silicon, aluminum nitride, zirconia, silicon nitride, silicon carbide, molybdenum and tungsten. The support member 4000 may be formed by any of the materials described above. In addition, the support member 4000 may be formed of a material having thermal conductivity lower than that of the material of the print element substrate 2002, for example, a resin material.

Ink supply flow passages 4200 are formed in the support member 4000 to supply ink to the print element substrate 2002. The print head 1000 is configured such that the ink in accordance with the ink amount ejected and consumed through the ejection ports is supplied to ink supply flow passages 4200 from the ink tank (not shown). The print head may be configured such that the ink in the ink supply flow passage 4200 is supplied into the bubble generation chamber 3200 by a supply unit (not shown) to be forcibly supplied to the bubble generation chamber 3200. In addition, the print head may be configured such that the bubble generation chamber 3200 is filled with the ink by a negative pressure generated in the bubble generation chamber 3200.

The print element substrate 2002 adheres and is fixed to the support member 4000 such that the ink supply ports 2210 to 2230 are communicated with the corresponding ink supply flow passages 4200 of the support member 4000. The adhesion is performed by making the back surfaces of the outer peripheral parts in the print element substrate 2002 and the back surfaces in regions thereof between the ink supply port 2210 and the ink supply port 2220 and between the ink supply port 2220 and the ink supply port 2230 adhere to the support member 4000. An adhesive agent for adhesion preferably has a low viscosity, a low curation temperature, is cured in a short time and has ink resistance properties. For example, as to the adhesive agent, an adhesive agent having an epoxy resin as a major component and in a combined type of ultraviolet and thermal curing is used, wherein preferably a thickness of the adhesive layer is equal to or less than 50 μm.

An electrical wiring member 5000 in which electrical signal channels and power supply channels that apply electrical signals to the print element substrate 2002 to eject ink are formed has an opening in size corresponding to the print element substrate 2002. The print element substrate 2002 is arranged inside the opening and adheres to the support member 4000. Electrode terminals 5100 are formed near edge parts of the opening formed in the electrical wiring member 5000 to be connected to the electrode parts 2300 of the print element substrate 2000. An external signal input terminal (not illustrated) is formed in the end part of the electrical wiring member 5000 to receive an electrical signal from the inkjet printing apparatus 100. The electrode terminals 5100 and the external signal input terminal (not illustrated) are connected by a successive wiring pattern in beaten copper.

The electrical connection between the electrical wiring member 5000 and the print element substrate 2002 is established, for example, such that the electrode part 2300 of the print element substrate 2000 and the electrode terminal 5100 of the electrical wiring member 5000 are connected with each other by an electrical connection unit of wire bonding. It should be noted that this electrical connection part is sealed by the sealant 6100 for preventing corrosion by ink and damages by an external force. In addition, the gap between the print element substrate 2002 and the opening of the electrical wiring member 5000 is sealed by the sealant 6200.

In the present embodiment, the plurality of ejection ports 3100 are formed only in an inner region closer to the inside than the ink supply port 2210 and the ink supply port 2230 arranged outside in the print element substrate 2002. The plurality of electrothermal transducing elements 2100 are arranged in positions corresponding to the ejection ports 3100 respectively. That is, the electrothermal transducing elements 2100 and the ejection ports 3100 are arranged only in the region between the ink supply port 2210 and the ink supply port 2220 and in the region between the ink supply port 2220 and the ink supply port 2230. In this way, the electrothermal transducing elements 2100 and the ejection ports 3100 are arranged only in the regions (first region) interposed between the ink supply ports each other (between the liquid supply ports each other).

The electrothermal transducing elements 2100 are arranged only in the region between the ink supply port 2210 and the ink supply port 2220 and in the region between the ink supply port 2220 and the ink supply port 2230. Therefore each of the electrothermal transducing elements 2100 is arranged only in the region having a relatively uniform temperature distribution. Since each of the electrothermal transducing elements 2100 is arranged only in the region having a relatively uniform temperature distribution, ink properties of ink droplets ejected by a drive of each of the electrothermal transducing elements 2100 are maintained to be relatively uniform between the ink droplets.

At the time of driving the electrothermal transducing elements 2100, since temperatures in inks positioned in the surroundings of the electrothermal transducing element 2100 are relatively uniform between the respective ejection ports 3100, an ejection amount of ink droplets to be ejected is kept to be relatively constant. Therefore a difference in density does not occur on an image obtained as a result of the landing of ink droplets on the print medium between the ink droplets ejected from the respective ejection ports 3100 to keep the density to be relatively uniform. Thereby a high-quality print image can be obtained.

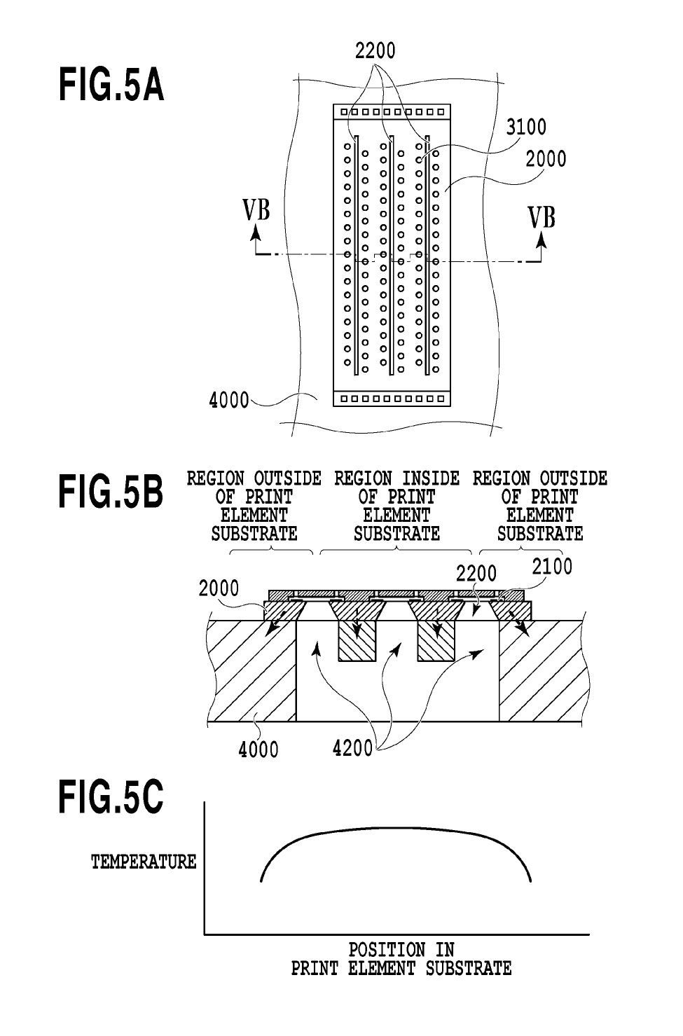

An explanation will be made of a comparative example in which electrothermal transducing elements 2100 are arranged in the region outside of each of ink supply ports 2210, 2230. FIG. 5A is a plan view illustrating a print element unit according to the comparative example, FIG. 5B is a sectional view taken along lines VB-VB in FIG. 5A and FIG. 5C is a graph illustrating a temperature distribution corresponding to positions of the print element substrate in FIG. 5B.

In a case of attaching the print element substrate on the support member, a volume of portions in the support member on which beam portions of the print element substrate between the ink supply ports are attached is regularly smaller than a volume of portions in the support member on which regions of the print element substrate outside of the ink supply ports are attached. Heat generated in the electrothermal transducing element for heating ink by driving the electrothermal transducing element is transferred through the print element substrate to the support member. At this time, an adhesion area between the print element substrate and the support member in the region between the ink supply ports each other is relatively narrow and the volume of the beam portion in the support member on which the print element substrate is attached is relatively small. Therefore the heat transferred to the support member through the print element substrate is relatively small.

On the other hand, in the region outside of the ink supply port, as illustrated in FIG. 5B, the print element substrate adheres to the portion in the support member that has a relatively large volume. Therefore among the heat generated when the electrothermal transducing element is driven in the region outside of the ink supply port, a relatively large deal of heat is transferred through the print element substrate to the support member. As a result, in the region outside of the ink supply port, a rise in temperature of ink positioned in the periphery of the electrothermal transducing element is suppressed to keep the temperature of the ink to be relatively low.

Accordingly, as illustrated in FIG. 5C, a difference in ink temperature between the region outside of the ink supply port and the region between the ink supply ports each other occurs in the temperature distribution for each position in the print element substrate. Therefore in regard to a temperature of the ink reserved inside the print element substrate, a temperature difference occurs between the region outside of the ink supply port and the region between the ink supply ports each other. In a case where ink droplets are ejected from the ejection ports for printing in this state, an ejection amount of the ink droplets ejected from the ejection port in the region outside of the ink supply port differs from that of the ink droplets ejected in the region between the ink supply ports each other. Accordingly, a difference in density of an image obtained as a result of the landing of the ink droplet occurs between the ink droplets ejected from the ejection port in the region outside of the ink supply port and the ink droplets ejected in the inside region between the ink supply ports each other. Since a difference in density of an image obtained as a result of the landing of the ink droplet occurs depending upon the position of the ejection port, there is a possibility that density unevenness occurs in the print image, thereby degrading the print image in quality.

In contrast, in the present embodiment, the ejection ports 3100 and the electrothermal transducing elements 2100 are arranged only in the inside region between the ink supply port 2210 and the ink supply port 2230. In addition, the ink droplets are ejected from the ejection ports 3100 by driving the electrothermal transducing elements 2100 positioned in the inside region between the ink supply port 2210 and the ink supply port 2230. In the inside region between the ink supply port 2210 and the ink supply port 2230, as illustrated in FIG. 5C, the temperature distribution in the print element substrate 2002 is relatively uniform, and a temperature difference of ink for each position does not occur so much, and the temperature distribution of ink is relatively uniform.

In this way, in the liquid ejecting head of a type where the electrothermal transducing element and the ejection port are formed only in the region between the ink supply ports each other in the print element substrate, the temperature difference for each position between the ejection ports each other is hard to occur. In the inks to be ejected, the temperature difference for each position of the ejection port is relatively hard to occur, and therefore a difference in ejection amounts of ink between ink droplets each other does not occur so much depending upon the position of each of the electrothermal transducing element and the ejection port. Accordingly, in the print image obtained by ejection of ink droplets, the density difference between the ink droplets does not occur so much, thus making it possible to suppress the density unevenness from occurring in the print image. Therefore it is possible to maintain the quality of the print image to be high.

In addition, in the present embodiment, the print element substrate 2002 adheres and is fixed to the support member 4000 in the region outside of each of the ink supply ports 2210, 2230 in the print element substrate 2002. Further, the back surface of the print element substrate 2002 in the region between the ink supply port 2210 and the ink supply port 2230 adheres and is fixed to the beam parts 4300 of the support member 4000.

For securing a contact area between the print element substrate 2002 and the support member 4000, an opening of the ink supply port 2200 of the print element substrate 2002 in the support member 4000-side is preferably at a constant distance from a lateral face of the print element substrate 2002. Therefore a constant region is provided between the ink supply port 2210 and one lateral face of the print element substrate 2002 adjacent thereto and between the ink supply port 2230 and the other lateral face of the print element substrate 2002 adjacent thereto. Further, at the time of attaching and connecting the print element substrate 2002 to the support member 4000, it is necessary to secure a strength of the print element substrate 2002 itself. Also from this point of view, the print element substrate 2002 is preferably configured in such a manner as to provide a constant distance from the lateral face of the print element substrate 2002 to the ink supply port 2200.

For this reason, in the present embodiment, a constant region of the print element substrate 2002 is present to the end in a width direction (second direction) outside of each of the ink supply port 2210 and the ink supply port 2230. Further, the electrothermal transducing elements 2100 and the ejection ports 3100 are arranged only in the region between the ink supply port 2210 and the ink supply port 2230 each other. Therefore a relatively large region in the print element substrate 2002 in which the electrothermal transducing element 2100 and the ejection port 3100 are not arranged is present in the region outside of each of the ink supply port 2210 and the ink supply port 2230.

Further, in the print element substrate 2002 each of the ink supply ports 2210 to 2230 is formed by anisotropic etching. Therefore each of the ink supply ports 2210 to 2230 is opened to be narrower in a tapered shape from an adhesion face with the support member 4000 to a formation face for the electrothermal transducing element 2100. Therefore on the face of the print element substrate 2002 on which the electrothermal transducing element 2100 is formed, each opening of the ink supply port 2210 and the ink supply port 2230 is formed in a position farther from the lateral face of the print element substrate 2002 than from the adhesion face of the support member 4000. Since each of the ink supply ports 2210 and 2230 is thus formed in the tapered shape, a wider space can be formed in the region outside of each of the ink supply port 2210 and the ink supply port 2230 in the print element substrate 2002.

Thus the relatively large space is generated in the region outside of each of the ink supply port 2210 and the ink supply port 2230 on the print element substrate 2002 by not arranging the electrothermal transducing element 2100 and the ejection port 3100 therein. In the present embodiment, a drive circuit 2400 for driving the electrothermal transducing element 2100 is arranged in the space generated in the region outside of each of the ink supply port 2210 and the ink supply port 2230. That is, the drive circuit 2400 for driving the electrothermal transducing element 2100 is arranged at least in the outside region (second region) of the region interposed between the ink supply ports each other. It is possible to efficiently use the space by forming the drive circuit 2400 in this region.

Since the drive circuit 2400 can be arranged in the space outside of each of the ink supply port 2210 and the ink supply port 2230 in which the drive circuit 2400 has not been arranged originally, the number of the drive circuits 2400 that will be arranged between the ink supply port 2210 and the ink supply port 2230 can be reduced. As a result, it is possible to reduce the space between the ink supply port 2210 and the ink supply port 2230 each other to be small to miniaturize the print element substrate 2002.

In the present embodiment, the drive circuits 2400 for driving the electrothermal transducing elements 2100 are arranged in the regions between the ink supply ports 2210 to 2230 each other. That is, the drive circuits 2400 are arranged not only in the regions outside of each of the ink supply ports 2210, 2230 each having the space, but also in the regions between the ink supply port 2210 and the ink supply port 2230 each other. Therefore it is possible to efficiently use the space of the print element substrate 2002. Specific examples of the drive circuit 2400 include a shift register or a decoder involved in signal generation for selecting the electrothermal transducing element 2100 to be driven or wiring for supplying a signal and power to the selected electrothermal transducing element 2100. In addition, the drive circuit 2400 also includes wiring connected to a diode sensor formed on the print element substrate 2002 for measuring the temperature or the like.

It should be noted that in the above embodiment, the electrode parts 2300 are formed outside of the print element substrate 2002 both in the longitudinal direction, but the present invention is not limited thereto. The position of the electrode part 2300 may be changed in design such that the electrode parts 2300 are formed not in both the ends of the print element substrate 2002 in the longitudinal direction, but only in one side end thereof.

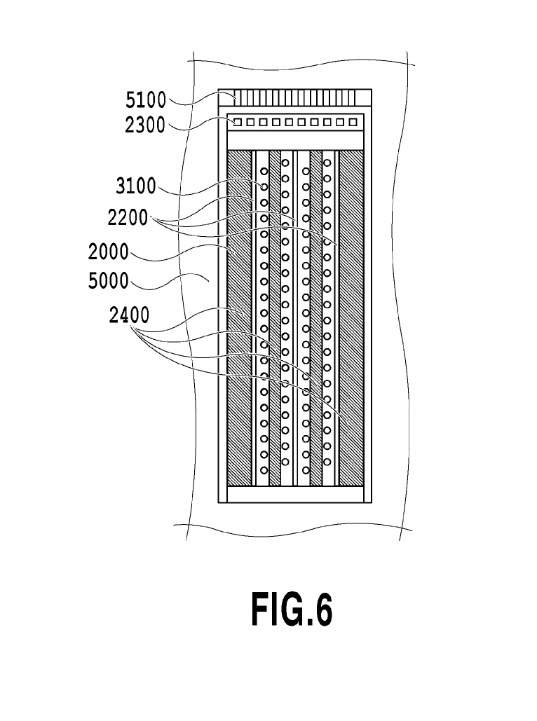

An explanation will be made of the print element substrate in this case with reference to FIG. 6. As illustrated in FIG. 6, in the print element substrate in this example, the electrode parts 2300 for supplying electrical signal to the electrothermal transducing element are formed only in one side end of the print element substrate in the longitudinal direction. As illustrated in FIG. 6, the print element substrate in this example differs in a point where the number of the electrothermal transducing elements does not change and the electrode parts 2300 are formed only in one side end of the print element substrate, compared to the print element substrate 2002 as illustrated in FIG. 4. As a result, the number of the drive circuits connected to the electrode parts 2300 at one side is increased. In this case, since it is necessary to supply electrical signals also to portions away from the electrode part 2300, the wiring is made longer to increase areas necessary for the drive circuits.

Therefore it is preferable to arrange the drive circuits corresponding to the increased number of the drive circuits in the space generated outside of the ink supply port by arranging the electrothermal transducing element only in the region between the ink supply ports each other. The drive circuit 2400 connected to the electrothermal transducing element formed near the end of the print element substrate 2002 in the side where the electrode part 2300 is not arranged is arranged also in the space outside of the ink supply port. Therefore it is possible to efficiently use the space of the print element substrate 2002.

Further, also in a case of making a design change to arrange another new circuit to the print element substrate 2002, likewise it is possible to arrange the circuit in the space generated outside of the ink supply port. With this configuration, it is possible to more efficiently use the space generated outside of the ink supply port.

The drive circuit 2400 is formed also between the end of the print element substrate 2002 in the longitudinal direction and the ink supply port 2200. Since the electrothermal transducing elements 2100 are arranged over almost an entire region of the print element substrate 2002, signal wiring and power supply wiring connected to the electrothermal transducing elements 2100 are distributed over almost the entire region of the print element substrate 2002. In addition, since the diode sensor is generally arranged in the region along the longitudinal center line of the print element substrate 2002, the wiring connected to the electrode parts 2300 is distributed in a wide region of the print element substrate 2002. From the above, a part of the wiring connected to the electrode parts 2300 is distributed in the width direction of the print element substrate 2002, that is, in a direction crossing the extension direction of the ink supply ports 2210 to 2230. Therefore a part of the wiring is arranged crossing the ink supply ports 2210 to 2230.

The plurality of ejection ports 3100 are opened in positions corresponding to the electrothermal transducing elements 2100 in both sides of the center ink supply port 2220 in the print element substrate 2002, and the ejection port arrays are formed such that one set is composed of two ejection port arrays. Any of the formed ejection port arrays has the same arrangement density of the ejection ports 3100. In addition, the ejection ports 3100 constituting two ejection port arrays arranged along the center ink supply port 2220 are arranged to be shifted by a half pitch with each other. In addition, the ejection ports 3100 arranged along the ink supply port 2210 and the ejection ports 3100 arranged along the ink supply port 2230 are arranged to be shifted by a half pitch with each other. The electrothermal transducing element 2100 and the ejection port 3100 are not arranged in the region between the lateral face of the print element substrate 2002 and each of the ink supply ports 2210, 2230.

As a result, in a case where the printing is performed with one pass by the print head in the present embodiment, at the time of printing one pixel on the print medium, the ejection port passes a certain spot on the print medium twice in total to perform the printing.

The flow of ink in the present embodiment enters into each of the bubble generation chambers 3200 from the ink supply flow passages 4200 of the support member 4000 through the ink supply ports 2210 to 2230 of the print element substrate 2000. In this way the ink is supplied into the bubble generation chamber 3200. When a drive pulse is applied to the electrothermal transducing element 2100 in a state where the bubble generation chamber 3200 is filled with the ink, thermal energy is given to the ink to generate film boiling in the ink. Rising of air bubble pressures generated by the bubble generating in the ink at this time causes ink droplets to be ejected from the ejection port 3100.

In the print element unit 1100 of the present embodiment, the ink of the same color is ejected in all the ejection port arrays. Since the plurality of ejection ports 3100 are arranged in arrays on the print element substrate 2002 in the present embodiment, the ejection port 3100 passes the same spot on the print medium by a plurality of times. Therefore an image pattern at the printing is printed for each of the ejection port arrays in a dispersing manner. The ejection ports used for ejection of ink are dispersed to be used for each of the ejection port arrays, which can suppress a particular ejection port or ejection port array from being intensively used for the ejection of the ink. Accordingly, the heat generating amount for each region in which the ejection port array is formed can be made more uniform.

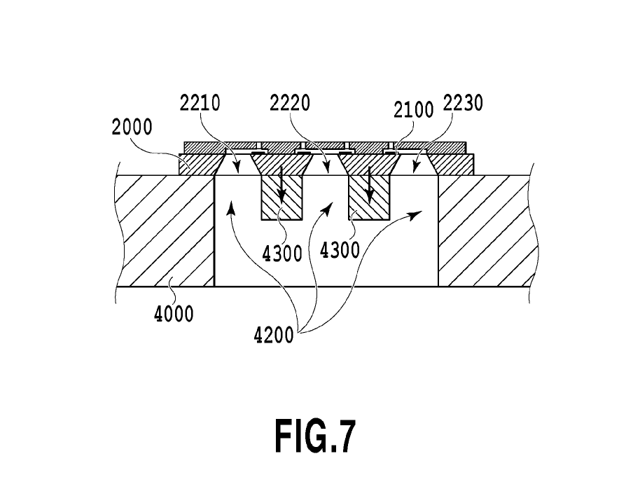

The ink supply ports 2200 are formed to penetrate the print element substrate 2002. Therefore in regard to the heat generated in an ejection port array in one region in the print element substrate 2002, the heat amount to be transferred to another region in the print element substrate 2002 across the ink supply port 2200 is relatively small. FIG. 7 is a sectional view illustrating the print element substrate 2002 of the present embodiment in which transfer directions of heat generated at the time of driving the electrothermal transducing element 2100 are indicated. As illustrated in arrows Y, a heat transfer route from the print element substrate 2002 to the support member 4000 concentrates on the print element substrate 2002 from between the ink supply ports to the beam part 4300 of the support member 4000. In the present embodiment, the respective volumes of the beam parts 4300 are substantially equal. Therefore the heat amount to be transferred from the print element substrate 2002 to the support member 4000 in each region in which the ejection port array is arranged is substantially uniform in each region.

From the above, any of the heat generating amount from the print element substrate 2002 and the heat amount transferred from the print element substrate 2002 to the support member 4000 during the operating of the print head 1000 becomes substantially uniform in each region of the ejection port arrays to be used for printing. Therefore the occurrence of the temperature distribution in each ejection region in which the ejection ports 3100 of the print element substrate 2002 are arranged in array is suppressed, making it possible to provide the print head 1000 in which the ejection amount of ink for each of the ejection ports 3100 is kept to be uniform. Accordingly, in the print image obtained as a result of the landing of the ink droplets on the print medium, it is possible to suppress occurrence of a difference in density for each ink droplet. Therefore it is possible to suppress occurrence of the density unevenness in the print image.

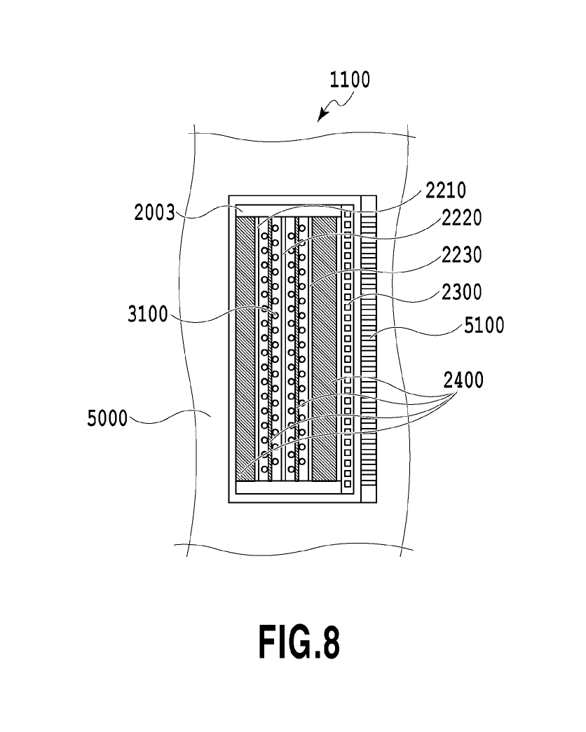

It should be noted that a print element substrate 2003 as illustrated in FIG. 8 may be used as the print element substrate. FIG. 8 is a plan view illustrating a modification in which a print element substrate 2003 and an electrical wiring member 5000 are supported by the support member 4000. In the modification illustrated in FIG. 8, the electrode parts 2300 are arranged only in the end of the print element substrate 2003 in one side in the width direction thereof along the longitudinal direction of the print element substrate 2003.

In the print element substrate 2003 of this modification, an interval of each other between the ink supply ports 2210 to 2230 is formed to be narrower than that in the print element substrate 2002. Further, the ink supply ports 2210 to 2230 are arranged closer to one side of the print element substrate 2003 in the width direction thereof where the electrode parts 2300 are not arranged. As similar to the print element unit using the print element substrate 2002, any of the heat generating amount from the print element substrate 2003 and the heat amount transferred from the print element substrate 2003 to the support member 4000 during the operating of the print head 1000 becomes substantially uniform in each region of the ejection port arrays.

Also in the modification as illustrated in FIG. 8, the electrothermal transducing element 2100 and the ejection port 3100 are not arranged in the region outside of each of the ink supply ports 2210, 2230. In addition, the drive circuit 2400 is arranged in the region, which is generated thereby, outside of each of the ink supply ports 2210, 2230 to drive the electrothermal transducing element 2100. Therefore it is possible to provide the print element unit in which the occurrence of the temperature distribution for each of ejection regions where the ejection ports 3100 of the print element substrate 2003 are arranged in array is suppressed and the occurrence of the density unevenness is suppressed. In addition it is possible to provide the print head with the print element unit that is configured as above.

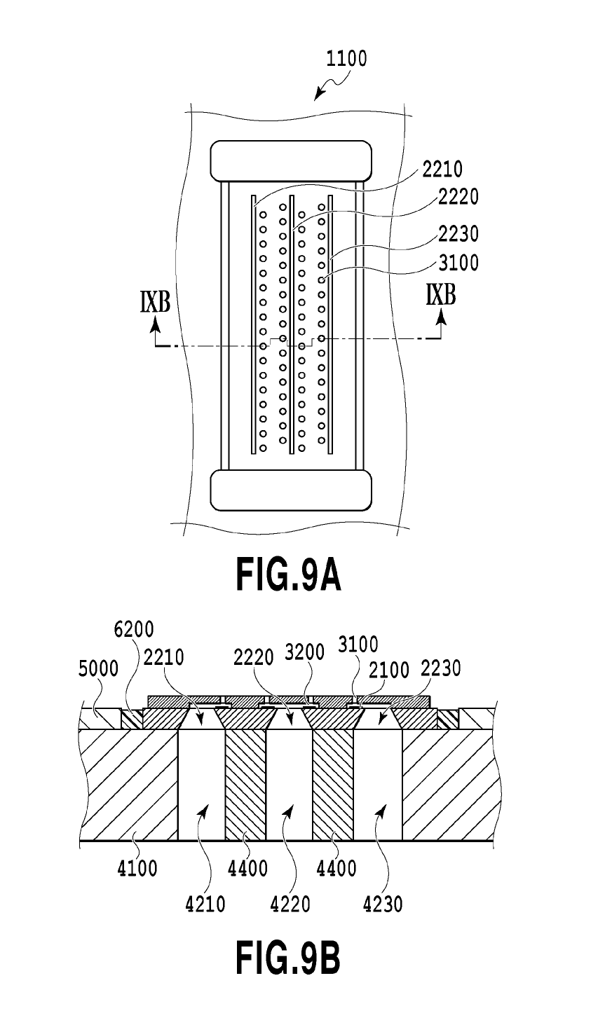

Further, as illustrated in FIGS. 9A and 9B, there may be used a support member 4100 in which the beam parts 4300 extend into an ink supply flow passage 4200. As a result, the support member 4100 is configured such that wall parts 4400 formed in regions between ink supply ports each other partition ink supply flow passages 4210 to 4230 into three independent flow passages. FIG. 9A is a plan view illustrating the support member 4100 and the print element substrate 2002 according to a different modification. FIG. 9B is a sectional view taken along lines IXB-IXB in FIG. 9A.

By using the support member 4100 of which the wall parts 4400 respectively define the ink supply flow passages 4210 to 4230, different inks can be supplied to the ink supply flow passages 4210 to 4230 in the support member 4100 respectively. Therefore inks of different colors supplied respectively to the ink supply flow passages 4210 to 4230 can be separated for use. In this way the support member 4100 can be configured such that different kinds of inks flow into the ink supply port 2210 to 2230 each.

In addition, the print element unit 1100 may use the same kind of ink as inks to be supplied respectively to the ink supply flow passages 4210 to 4230 in the support member 4100.

In the print element unit 1100, inks of different colors may be ejected between ejection ports corresponding to the ink supply flow passages 4210, 4230 formed in both the sides of the support member 4100 and ejection ports corresponding to the center ink supply port 2220 thereof. In a case of ejecting inks of two colors, ink can be ejected so that an image pattern corresponding to one-color is dispersed to be ejected from the ejection ports 3100 arranged along the ink supply port 2210 and the ink supply port 2230 formed in both the sides. Therefore the heat generating amounts by driving the electrothermal transducing elements 2100 in the regions in which the ejection port arrays are arranged between the ejection port array along the ink supply port 2210 and the ejection port array along the ink supply port 2230 formed in both the sides are substantially uniform.

In addition, an image pattern corresponding to the other-color ejected from the two ejection port arrays arranged along the center ink supply port 2220 is dispersed in the respective ejection port arrays for printing. Accordingly, in any of a combination of the ink supply port 2220 and the ink supply port 2210 and a combination of the ink supply port 2220 and the ink supply port 2230, the heat generating amount in the region in which the two ejection port arrays are arranged between the ink supply ports is substantially uniform in each region. In addition, in a case where ink of the same color is ejected from all the ejection port arrays, since the image pattern at the printing is dispersed to each ejection port array for printing, the heat generating amount for each of the regions wherein the ejection port arrays are arranged is substantially uniform.

The heat transferred from the print element substrate 2000 to the support member 4100 reaches the wall parts 4400 of the support member 4100 through the regions between the ink supply ports 2210 to 2230 of the print element substrate 2002. Each of areas in the regions between the ink supply ports 2210 to 2230 of the print element substrate 2002 is substantially equal between the respective regions. Therefore the heat amount transferred from the print element substrate 2002 to the support member 4100 in each of the regions where the ejection port arrays are arranged is substantially uniform between the respective regions.

From the above, both the heat generating amount from the print element substrate 2000 and the heat transferring amount from the print element substrate 2000 to the support member 4100 at the operating of the print head are the same as those in a case of using the support member 4000. Therefore even in a case of using the support member 4100 illustrated in FIG. 9B, there can be provided the print element unit and the print head that can suppress the density unevenness.

In addition, since the wall part 4400 of the support member 4100 has a larger volume than the beam part 4300 of the support member 4000, the heat amount transferred from the print element substrate 2000 to the support member 4100 increases. Therefore heat release of the print element substrate 2002 can be more efficiently performed to suppress a rise in temperature of the print element substrate 2002 more securely.

The explanation is made of a case where in the aforementioned embodiments the three arrays of the ink supply ports 2210 to 2230 are provided in each of the print element substrates 2002, 2003 and each of the support members 4000, 4100 is configured in accordance with the structure. However, the present invention is not limited thereto. The present invention may adopt the other configuration as long as a plurality of ink supply ports are provided on a print element substrate, wherein electrothermal transducing elements are arranged in the region therebetween on the print element substrate, and a support member is structured corresponding thereto. For example, the number of the ink supply ports are not limited to three, but may be four or more, or two.

### Second Embodiment

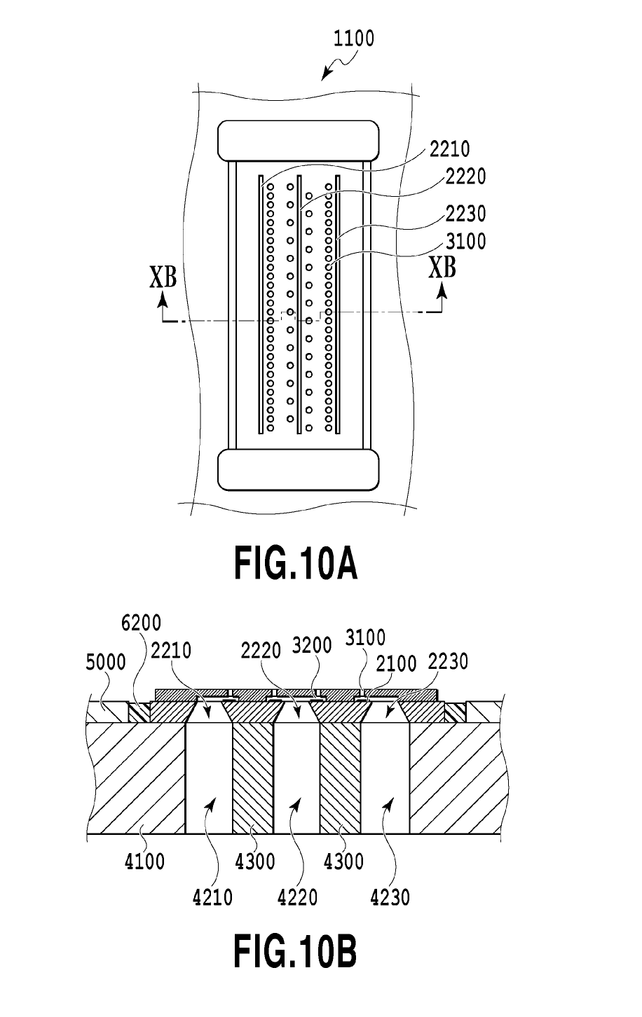

Next, an explanation will be made of a second embodiment in the present invention. FIG. 10A is a plan view illustrating a print element unit 1100 used in a print head according to the second embodiment, and FIG. 10B is a sectional view illustrating the print element unit 110, taken along lines XB-XB in FIG. 10A. In a case of actually viewing the print element unit 1100 from a side where ink droplets are ejected, ink supply ports 2210 to 2230 cannot be viewed, but are herein illustrated for explanation.

As illustrated in FIG. 10A, the print element unit 1100 is provided with the three ink supply ports 2210 to 2230. A plurality of ejection ports are formed only between the neighboring ink supply ports to form ejection port arrays.

According to the present embodiment, the ejection port array formed along each of the ink supply ports 2210, 2230 formed outside, among the three ink supply ports 2210 to 2230, is formed such that an arrangement concentration of the ejection ports 3100 is relatively high. Each of the ejection port arrays formed along the ink supply port 2220 formed in the center is formed such that an arrangement concentration of the ejection ports 3100 is relatively low. That is, in the present embodiment, in regard to the arrangement concentration of the ejection ports 3100 in the ejection port array, the ejection ports 3100 are arranged such that the ejection port array formed along each of the outside ink supply ports 2210, 2230 is “close”, and each of the ejection port arrays formed along the center ink supply port 2220 is “sparse”.

In addition, the arrangement concentration of the ejection ports in one of the ejection port arrays arranged along the outside ink supply ports 2210, 2230 is equal to the arrangement concentration of the ejection ports in a combination of the two ejection port arrays arranged at both the sides of the center ink supply port 2220.

In this way, as compared with the first embodiment, the ejection port arrays are arranged in the print element unit 1100 such that the arrangement concentration of the ejection ports arranged along each of the ink supply ports 2210, 2230 arranged outside becomes higher. Therefore according to the print head in the second embodiment, it is possible to perform a print more finely by ink droplets ejected from the ejection port array arranged along each of the outside ink supply ports than in the print head of the first embodiment.

The configuration in the present embodiment other than the above is similar to that of the first embodiment, and also in the present embodiment, the plurality of ejection ports 3100 and the plurality of electrothermal transducing elements 2100 are arranged only in the region between the ink supply ports 2210, 2230 formed outside. In addition, by arranging the ejection ports 3100 and the electrothermal transducing elements 2100 only in the region of each other between the ink supply ports 2210 to 2230, a relatively large space is formed outside of each of the ink supply ports 2210, 2230. A drive circuit 2400 is arranged in the space generated outside of each of the ink supply ports 2210, 2230 to drive the electrothermal transducing elements 2100. Thereby it is possible to more efficiently use the space generated outside of each of the ink supply ports 2210, 2230.

The configuration of the present embodiment may be used as a print element unit of ejecting inks of the same color from all the ejection port arrays. In addition, in the present embodiment, the ink supply flow passages 4210 to 4230 are formed independently by being respectively sectioned within the support member 4100. Therefore the kinds of inks to be used can be made different between the ink supply ports 2210 to 2230 formed in the print element substrate 2002.

In addition, inks of two kinds of colors may be supplied to the print element substrate by making the kind of the ink to be supplied to the ink supply port 2220 formed in the center different from the kind of the ink to be supplied to the ink supply ports 2210, 2230 formed outside. In this case, in the present embodiment, the arrangement concentration of the ejection ports in a combination of the two ejection port arrays arranged at both the sides of the center ink supply port 2220 is a half of the arrangement concentration of the ejection ports in a combination of the ejection port arrays arranged along the ink supply ports 2210, 2230.

From the above, it is possible to eject ink, by which image formation is made without any problem even at a low resolution, from the ejection ports connected to the center ink supply port 2220, such as an ink of black. In addition, it is possible to eject a color ink suitable for printing at a high resolution from the ejection ports connected to the outside ink supply ports 2210, 2230.

Further, a size of the electrothermal transducing elements 2100 or the ejection ports 3100 arranged along the ink supply ports 2210 to 2230 in array may vary between the ink supply port 2220 arranged in the center and the ink supply ports 2210, 2230 arranged outside. In this case, it is preferable that a total of heat generating amounts of the electrothermal transducing elements 2100 arranged between the ink supply ports 2210, 2220 is substantially equal to a total of heat generating amounts of the electrothermal transducing elements 2100 arranged between the ink supply ports 2220, 2230.

In addition, in regard to the arrangement concentration of the ejection ports in the ejection port array, the arrangement concentration of the ejection ports of the ejection port array along each of the outside ink supply ports 2210, 2230 may be made “sparse” in reverse to the relation of the arrangement as described above, and in accordance with it, the ejection ports may be arranged such that the arrangement concentration of the ejection ports in the ejection port array along the center ink supply port 2220 is “close”.

However, in a case of arranging the ejection ports in each of the ejection port arrays as described above, the following event possibly occurs. That is, when a relatively large amount of inks are ejected from the ejection ports connected to the center ink supply port 2220, there are some cases where the heat that is too large to be transferred to the support member 4100 is generated in the periphery of the electrothermal transducing element 2100. Since the center ink supply port 2220 is formed to be interposed between the two ejection port arrays, the heat generated in the periphery of the electrothermal transducing element 2100 tends to be easily transferred to the ink inside the ink supply port 2220. In this case, since the arrangement concentration of the ejection ports in the ejection port array connected to the center ink supply port 2220 is relatively high, the arrangement concentration of the electrothermal transducing elements 2100 is also relatively high. Accordingly, a relatively large deal of heat is generated in the periphery of the center ink supply port 2220. Therefore the large deal of heat is transferred to the ink inside the center ink supply port 2220, and a temperature of ink in the periphery of the center ink supply port 2220 possibly becomes higher than a temperature of the ink in the periphery of the outside ink supply ports 2210, 2230. When such a change in characteristics of ink is allowable, the arrangement concentration of the ejection ports of the ejection port array along each of the outside ink supply ports 2210, 2230 may be made “sparse”. In addition, the ejection ports may be arranged such that the arrangement concentration of the ejection ports in the ejection port array along the center ink supply port 2220 is “close”.

It should be noted that also in the present embodiment, the explanation is made of the mode in which the three ink supply ports 2210 to 2230 are formed in the print element substrate 2002, but the present invention is not limited thereto. The number of the ink supply ports may be other than three. When three or more ink supply ports are formed, it is allowed only if colors of inks flowing in each of the ink supply ports in both ends at the outermost and in the inside ink supply port can be respectively determined in such a manner as to differ from each other.

### Third Embodiment

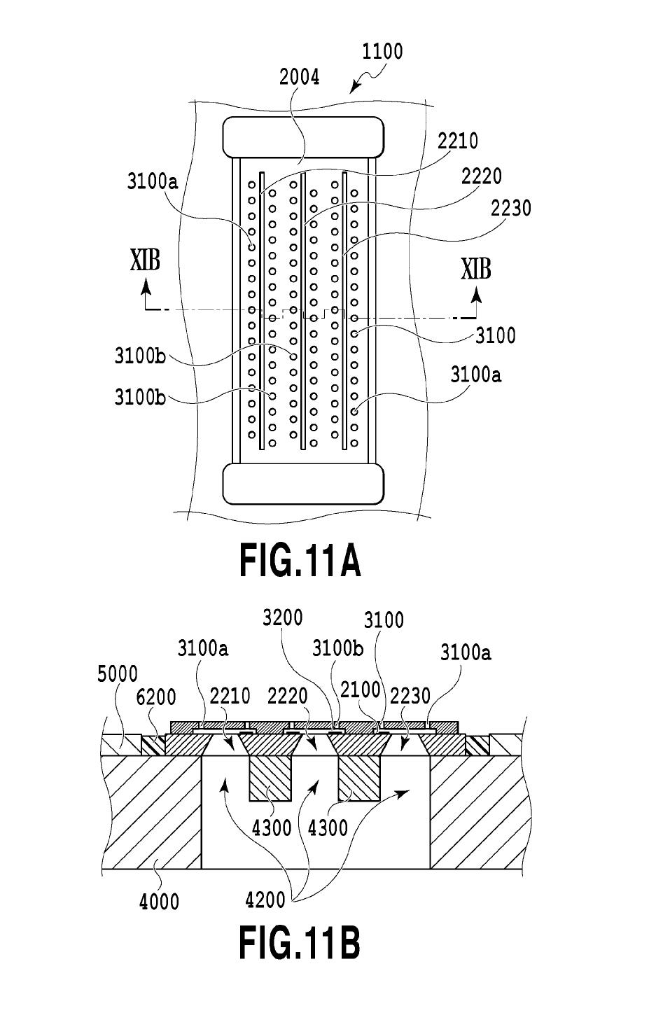

Next, an explanation will be made of a third embodiment in the present invention. FIG. 11A is a plan view illustrating a print element unit 1100 used in a print head according to the third embodiment in the present invention, and FIG. 11B is a sectional view taken along lines XIB-XIB in FIG. 11A. In a case of actually viewing the print element unit 1100 from a side where ink droplets are ejected, ink supply ports 2210 to 2230 cannot be viewed, but are herein illustrated for explanation.

In the print element unit 1100 of the third embodiment, as illustrated in FIG. 11B, electrothermal transducing elements and ejection ports are arranged in positions between the ink supply ports in the print element substrate 2004. The ejection ports are arranged in positions corresponding to the electrothermal transducing elements for ejecting ink. In a region outside of each of the ink supply ports at the outermost, there is not electrothermal transducing elements, but ejection ports are arranged therein. The ejection ports are formed as dummy ejection ports that are not involved in ejection of ink.

In the present embodiment, bubble generation chambers 3200 and ejection ports 3100 arranged on the print element substrate 2004 are made of resin materials and formed by a photolithographic technology. As the first embodiment and the second embodiment, in a case where the ejection ports 3100 are formed only in one side of each of the ink supply ports 2210, 2230, there is a possibility that flatness in the print element unit 1100 in the vicinity of the ejection port 3100 is degraded. As a result, positional accuracy of the ejection port 3100 at the manufacture of the print element substrate 2004 is degraded, thereby possibly degrading the landing accuracy of ink droplets on a print medium. This is a phenomenon that occurs because the ejection port arrays are not arranged to be symmetric to each of the ink supply ports 2210, 2230.

On the other hand, in the third embodiment, there is not the electrothermal transducing elements 2100 but there are the dummy ejection ports 3100a that are not involved in ink ejection. The dummy ejection ports are arranged in the region outside of each of the ink supply ports 2210, 2230 positioned at the outermost. Since the dummy ejection ports 3100a are arranged in such a manner, the ejection ports are arranged to be symmetric to each of the ink supply ports 2210, 2230 formed at the outermost.

Since the ejection ports are arranged to be symmetric to the ink supply ports 2210, 2230 respectively, the flatness of the print element unit 1100 near the dummy ejection ports 3100a and the ejection ports 3100b that are formed in the region between the ink supply ports 2210 to 2230 for ejecting ink is improved. Accordingly the high flatness of the print element unit 1100 is maintained also in the region outside of each of the ink supply ports 2210, 2230. Thereby the positional accuracy of the ejection port is improved to improve the landing accuracy of ink droplets on the print medium. Therefore at the time of ejecting ink from the ejection port, the high landing accuracy by ink droplets is maintained. Since the landing accuracy of the ink is highly maintained, it is possible to maintain high quality of a print image.

The print element unit 1100 of the present embodiment is configured to be similar to the first embodiment and the second embodiment except that the dummy ejection port 3100a is arranged in the region outside of each of the ink supply ports 2210, 2230. The electrothermal transducing elements 2100 are arranged only in the regions between the ink supply ports 2210 to 2230 each other, and the ejection ports 3100 that eject ink are formed only in the regions between ink supply ports 2210 to 2230. That is, the print element unit 1100 is configured such that the ejection ports that eject ink are formed only in the inside region between the ink supply ports 2210 and 2230 formed at the outermost.

In addition, the dummy ejection port 3100a as explained in the present embodiment may be formed also on the print element substrate 2002 having the structure as explained in the second embodiment. Further, in the present invention, a dummy heater element corresponding to the dummy ejection port and a dummy wiring connected to the dummy heater element may be provided. These are not used for the printing onto the print medium. There are some cases where it is preferable to provide the above dummy wiring, dummy heater element, dummy ejection port and the like at the manufacture of the liquid ejecting head for an improvement on the dimension accuracy and positional accuracy. Thus providing the dummy heater element and the like enables the high-accuracy liquid ejecting head to be provided, and further, not using the dummy heater element and the like for printing leads to an improvement on the print quality.

### Fourth Embodiment

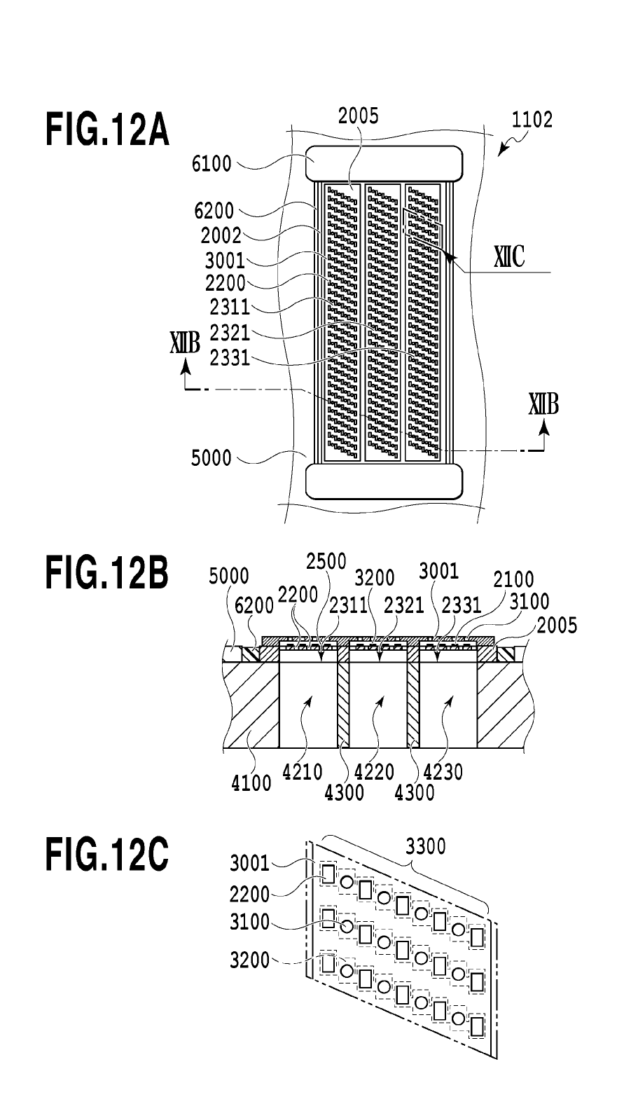

Next, an explanation will be made of a fourth embodiment in the present invention. FIG. 12A is a plan view illustrating a print element unit 1102 used in a print head according to the fourth embodiment, and FIG. 12B is a sectional view taken along lines XIIB-XIIB in FIG. 12A. Further, FIG. 12C is an enlarged view illustrating a region XIIC in FIG. 12A. In a case of actually viewing the print element unit 1102 from a side where ink droplets are ejected, ink supply ports 2210 to 2230 cannot be viewed, but are herein illustrated for explanation.

In the present embodiment, the print element unit 1102 is configured such that a print element substrate 2005 is attached on a support member 4100, and an ejection port plate 3001 is attached on the print element substrate 2005. Three common ink chambers 2311, 2321, 2331 are formed in the print element substrate 2005. Three ink supply flow passages 4210, 4220, 4230 are formed in the support member 4100. The print element substrate 2005 is attached on the support member 4100 such that the common ink chambers 2311, 2321, 2331 in the print element substrate 2005 are communicated with the ink supply flow passages 4210, 4220, 4230 in the support member 4100 respectively.

Ink flow passages 2500 are formed between the ejection port plate 3001 and the print element substrate 2005. Electrothermal transducing elements 2100 are formed on the print element substrate 2005 to face the ink flow passages 2500 between the ejection port plate 3001 and the print element substrate 2005. The print element substrate 2005 is provided with a plurality of ink supply ports 2200 formed to penetrate therethrough from the front surface to the back surface. In addition, the common ink chambers 2311, 2321, 2331 are formed in the print element substrate 2005 in the side attached to the support member 4100.

In the present embodiment, the ink supply port 2200 is formed to extend along the longitudinal direction (first direction) of the print element substrate 2005, and comprises a plurality of ink supply ports 2200 arranged along a width direction (second direction) crossing the longitudinal direction of the print element substrate 2005. Ejection ports 3100 are interposed between the plurality of ink supply ports 2200 arranged in the width direction of the print element substrate 2005, and the plurality of ink supply ports 2200 and the plurality of ejection ports 3100 are alternately formed in the width direction.

As a result, in the present embodiment, a plurality of bubble generation chambers 3200 are arranged along the width direction of the print element substrate 2005, and the plurality of bubble generation chambers 3200 arranged along the width direction are communicated with each other to form a bubble generation chamber group 3300. In the present embodiment, the plurality of bubble generation chamber groups 3300 are arranged in the longitudinal direction of the print element substrate 2005 to form an array of the bubble generation chamber groups 3300. The plurality of array of the bubble generation chamber groups 3300 are arranged along the width direction of the print element substrate 2005. In the present embodiment, three arrays of the bubble generation chamber groups 3300 are arranged on the print element substrate 2005.

The common ink chambers 2311, 2321, 2331 are respectively communicated with the ink flow passages 2500 through the ink supply ports 2200. The ink flow passages 2500 are formed between the ejection port plate 3001 and the print element substrate 2005. Four arrays of ejection ports 3100 and four arrays of the electrothermal transducing elements 2100 are arranged to one ink supply flow passage 4210 and one common ink chamber 2311. In addition, five arrays of ink supply ports 2200 are formed to one ink supply flow passage 4210 and one common ink chamber 2311.

The bubble generation chamber 3200 is formed between the electrothermal transducing element 2100 and the ejection port 3100. Bubbles are generated in ink by driving the electrothermal transducing element 2100 in a state where the ink is reserved in the bubble generation chamber 3200. At this time ink droplets are ejected from the ejection port with an increase in pressure in the ink.

The print element substrate 2005 and the ejection port plate 3001 are provided with the ejection ports 3100 and the ink flow passages 2500 formed by the photolithographic technology. The common ink chambers 2311, 2321, 2331 of the support member 4100 and the ink supply ports 2200 of the print element substrate 2005 in the present embodiment are formed by a dry etching method using mixed gases. Therefore wall faces that respectively define the common ink chambers 2311, 2321, 2331 and the ink supply ports 2200 are formed with high accuracy. In the present embodiment, these flow passages are formed to be substantially vertical to the front and back surfaces of the print element substrate 2005.

In the print element unit 1102 of the present embodiment, the ink supply ports 2200 of the print element substrate 2005 and the ejection ports 3100 of the ejection port plate 3001 are arranged alternately along the width direction of the print element substrate 2005.

The ejection port 3100 is interposed between the ink supply ports 2200, and the ejection port 3100 and the ink supply port 2200 are formed such that the ejection port 3100 is communicated with the ink flow passage 2500 communicated with the respective ink supply ports 2200. With this arrangement of the ejection port 3100 and the ink supply ports 2200, ink is supplied from the two ink supply ports 2200 to a position of the electrothermal transducing element 2100 corresponding to the ejection port 3100 for each of the ejection ports 3100. Since the ink is supplied for each of the ejection ports 3100 from the two ink supply ports 2200, the ink can be supplied to be well-balanced from the two ink supply ports 2200 to the electrothermal transducing element 2100 without bias. As a result, since air bubbles are formed to be well-balanced in the bubble generation chamber 3200, ink droplets are ejected from the ejection port with good accuracy. Therefore it is possible to improve the landing accuracy of the ink droplet on the print medium.

In the present embodiment as well, the electrothermal transducing element 2100 and the ejection port 3100 are arranged only in the region between the ink supply ports 2200 each other. In addition, on the print element substrate 2005, the electrothermal transducing element 2100 and the ejection port 3100 are not arranged in the region outside of each of the ink supply ports 2200 arranged at the outermost in the width direction. That is, the electrothermal transducing element 2100 and the ejection port 3100 are not arranged between the lateral face of the print element substrate 2005 in the longitudinal direction and the ink supply port 2200 in close proximity to the lateral face.

In the present embodiment also, the electrothermal transducing element 2100 and the ejection port 3100 are arranged only in the inside region between the ink supply ports 2200 formed at the outermost of the print element substrate 2005 in the width direction. Accordingly a difference in the temperature distribution for each region in the width direction of the print element substrate 2005 at the operating of the print head can be made small, and the temperature distribution in the width direction of the print element substrate 2005 becomes substantially uniform. Therefore it is possible to suppress occurrence of the density unevenness in the print image.

In addition, the drive circuit 2400 is arranged in the space generated by not arranging the electrothermal transducing element 2100 in the region outside of the ink supply port 2200 in the print element substrate 2005. Thereby it is possible to effectively use the space generated by not arranging the electrothermal transducing element 2100 to miniaturize the print head.

In addition, the drive circuits 2400 may be formed also in spaces between the common ink chambers 2311, 2321, 2331 each other. With this structure, it is possible to efficiently use the space in the print element substrate 2005.

In the present embodiment, ink flow through the ink supply flow passages 4200 in the support member 4100, subsequently the common ink chambers 2311, 2321, 2331 of the print element substrate 2002, and further, the ink supply ports 2200 into the bubble generation chambers 3200. Therefore electrical signals (pulse wave) are applied to the electrothermal transducing elements 2100 to eject ink droplets from the ejection ports 3100.

In the present embodiment, since the ink supply flow passages 4210 to 4230 formed in the support member 4100 are formed independently, an ink of a different color can be ejected for each of the ink supply flow passages 4210 to 4230. In addition, a color of the ink supplied to each of the ink supply flow passages 4210 to 4230 may be composed of the same color to eject the inks of the same color from all the ejection ports 3100 formed in the ejection port plate 3001. Further, the support member 4100 used in the first embodiment may be applied to the print head in the fourth embodiment, wherein the inks of the same color may be ejected from all the ejection ports 3100 formed in the ejection port plate 3001.

Since the ink supply port 2200 is formed to penetrate the print element substrate 2005, among the heat generated in the electrothermal transducing element 2100 the heat amount transferred over the ink supply port 2200 is small. The ink supply ports 2200 are provided in the outer peripheral part of each of the common ink chambers 2311 to 2331. Therefore the amount of heat to be transferred from the ejection port region formed in one common ink chamber to the ejection port region formed in another common ink chamber neighbored thereto also becomes small. Therefore the amount of the heat generated in each of the common ink chambers becomes substantially uniform over the entirety of the print element substrate 2005.

In the present embodiment, the explanation is made of a case where the three arrays of the common ink chambers 2311 to 2331 are provided in the print element substrate 2005, and the support member 4100 is configured to correspond thereto. However, the present invention is not limited thereto, but the number of the arrays of the common ink chambers may be two or more than three arrays. In this case, it is allowed only if in the support member 4100, the ink supply flow passages the number of which corresponds to the number of the common ink chambers are formed.

In the present embodiment, the explanation is made of a case where the four arrays of ejection ports 3100 and electrothermal transducing elements 2100 are arranged for one ink supply flow passage 4210 and one common ink chamber 2311. In addition, the explanation is made of a case where the five arrays of ink supply ports 2200 are formed for one ink supply flow passage 4210 and one common ink chamber 2311. However, the present invention is not limited thereto, but the number of the arrays of the ejection ports 3100 and electrothermal transducing elements 2100 or the number of the arrays of the ink supply ports 2200 may be the other number.

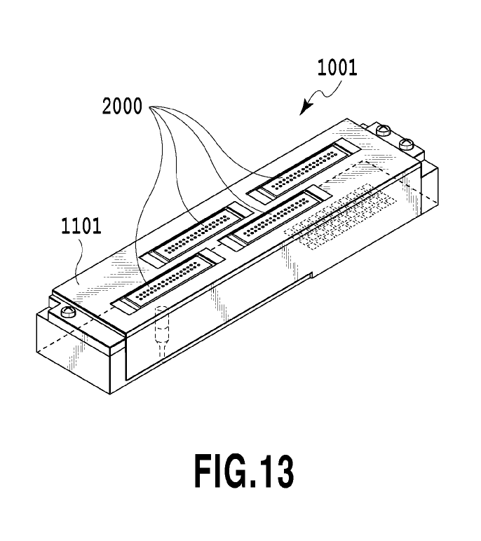

In the aforementioned embodiment, the explanation is made of a case of being applied to the inkjet printing apparatus of a serial scan system that prints while scanning in a state where the print head is mounted in the carriage. However, the present invention is not limited to the aforementioned embodiment, but, as illustrated in FIG. 13, may be applied to a full line type inkjet printing apparatus using a print head 1001 in which a plurality of print element substrates are arranged to extend over an entire region of the print medium in the width direction.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-177286, filed Sep. 1, 2014, which is hereby incorporated by reference wherein in its entirety.

What is claimed is:

1. A liquid ejecting head comprising:
an element substrate;
a support member that supports the element substrate; and
an ejection port plate that is mounted to the element substrate, wherein
a bubble generation chamber is defined between the element substrate and the ejection port plate to reserve liquids therein,
the element substrate is provided with a heater element that heats liquid reserved in the bubble generation chamber to generate bubbles, and a plurality of liquid supply ports formed to penetrate therethrough from a front surface on which the heater element is provided to a back surface as the reverse side to supply the liquid to the bubble generation chamber,
the ejection port plate is provided with ejection ports formed therein to eject the liquid from the bubble generation chamber by driving the heater element,
the back surface of a portion outside of the liquid supply port and a portion between the liquid supply ports each other in the element substrate is attached to the support member,
the heater element is arranged only in a first region of the element substrate interposed between the plurality of liquid supply ports each other, and
a drive circuit that drives the heater element is arranged at least in a second region outside of the first region.

2. The liquid ejecting head according to claim 1, wherein
the liquid supply port is formed to extend along a first direction, and
the first region is formed to be interposed between the plurality of liquid supply ports arranged in a second direction crossing the first direction.

3. The liquid ejecting head according to claim 2, wherein
a plurality of heater elements are arranged along the first direction.

4. The liquid ejecting head according to claim 3, wherein
a plurality of ejection ports are arranged along the first direction corresponding to the heater elements.

5. The liquid ejecting head according to claim 2, wherein
three or more liquid supply ports are formed along the second direction.

6. The liquid ejecting head according to claim 5, wherein
each of a plurality of ejection port array is arranged such that a concentration degree of the arrangement of the heater elements that heat the liquid reserved in the bubble generation chamber connected to the liquid supply port positioned at the outermost among the plurality of liquid supply ports is larger than a concentration degree of the arrangement of the heater elements that heat the liquid reserved in the bubble generation chamber connected to the liquid supply port positioned inside thereof.

7. The liquid ejecting head according to claim 5, wherein
a color of the liquid ejected from each of the ejection ports for ejecting the liquids from the bubble generation chamber connected to each of the liquid supply ports positioned at the outermost, among the three or more liquid supply ports formed along the second direction, differs from a color of the liquid ejected from each of the ejection ports for ejecting the liquids from the bubble generation chamber connected to the liquid supply port positioned inside, among the three or more liquid supply ports formed along the second direction.

8. The liquid ejecting head according to claim 2, wherein
an electrode is arranged in an end of the element substrate in the first direction to supply current for driving the heater element.

9. The liquid ejecting head according to claim 8, wherein
the electrode is arranged only in one end of the element substrate in the first direction to supply the current for driving the heater element.

10. The liquid ejecting head according to claim 2, wherein
an electrode is arranged in an end of the element substrate in the second direction to supply current for driving the heater element.

11. The liquid ejecting head according to claim 1, wherein
a dummy ejection port is formed in the second region to establish communication between the bubble generation chamber and an outside, without the corresponding heater element.

12. The liquid ejecting head according to claim 1, wherein
a plurality of liquid supply ports, formed to extend along the first direction, are arranged along a second direction crossing the first direction,
the ejection port is interposed between the plurality of liquid supply ports arranged in the second direction, and the plurality of liquid supply ports and the plurality of ejection ports are alternately formed along the second direction,
a plurality of bubble generation chambers are arranged along the second direction,
the plurality of bubble generation chambers arranged in the second direction are communicated with each other to form a bubble generation chamber group, and
a plurality of bubble generation chamber groups are arranged along the first direction to form an array of the bubble generation chamber groups.

13. The liquid ejecting head according to claim 12, wherein
a plurality of arrays of the bubble generation chamber groups are arranged along the second direction.

14. A liquid ejecting apparatus mounting a liquid ejecting head thereon, the liquid ejecting head comprising:
an element substrate;
a support member that supports the element substrate; and
an ejection port plate that is mounted to the element substrate, wherein
a bubble generation chamber is defined between the element substrate and the ejection port plate to reserve liquids therein,
the element substrate is provided with a heater element that heats the liquid reserved in the bubble generation chamber to generate bubbles, and a plurality of liquid supply ports formed to penetrate therethrough from a front surface on which the heater element is provided to a back surface as the reverse side to supply the liquid to the bubble generation chamber,
the ejection port plate is provided with an ejection port formed therein to eject the liquid from the bubble generation chamber by driving the heater element,
the back surface of a portion outside of the liquid supply port and a portion between the liquid supply ports each other in the element substrate is attached to the support member,
the heater element is arranged only in a first region of the element substrate interposed between the plurality of liquid supply ports each other, and
a drive circuit that drives the heater element is arranged at least in a second region outside of the first region.

15. A liquid ejecting head comprising:
a print element substrate including a plurality of heater elements that generate thermal energy used for ejecting liquids and a drive circuit that drives the heater elements; and
a support member that supports the print element substrate, wherein
a plurality of supply port arrays are provided in the print element substrate to penetrate the print element substrate and extend in a first direction for supplying the liquid to the heater elements, and are arranged along a second direction crossing the first direction,
the plurality of heater elements are arrange only in regions between the plurality of supply port arrays each other, and
the drive circuit is arranged in a region between a supply port array arranged at the outermost among the plurality of supply port arrays and an end of the print element substrate in the second direction.

16. The liquid ejecting head according to claim 15, wherein
a dummy ejection port that is not used for printing on a print medium is provided in the region between the supply port array arranged at the outermost among the plurality of supply port arrays and the end of the print element substrate in the second direction.

17. The liquid ejecting head according to claim 15, wherein
a dummy heater element that is not used for printing on a print medium is provided in the region between the supply port array arranged at the outermost among the plurality of supply port arrays and the end of the print element substrate in the second direction.
